(19) United States
(12) Patent Application Publication
(10) Pub. No.: US 2025/0363849 A1
(43) Pub. Date: Nov. 27, 2025

(54) SYSTEM AND ASSOCIATED METHODS FOR A TRANSACTION MACHINE INTERFACE DEVICE

(71) Applicant: PAC, Inc., La Crosse, WI (US)

(72) Inventor: JOHN HOLTSLANDER, La Crosse, WI (US)

(73) Assignee: PAC, Inc., La Crosse, WI (US)

(21) Appl. No.: 18/674,332

(22) Filed: May 24, 2024

(51) Int. Cl. G07F 9/02; G06F 3/01; G06Q 20/18

(52) U.S. Cl. CPC G07F 9/023; G06F 3/011; G06Q 20/18

(57) ABSTRACT

A transaction system may include a main body member and a user interface body member. The main body member may hold an inventory of goods. The user interface body member may be mounted to the main body member. The user interface body member may include a user interface, a controller, a detection unit, and an actuation member. The user interface may be carried by the user interface body member and may be operable to facilitate transactions and dispense the goods responsive to the transaction. The detection unit may sense a height of a user and may be operable to transmit a height detection signal. The actuation member may be operable to move the user interface between a raised position and a lowered position responsive to the height detection signal.

### FIELD OF THE INVENTION

The present invention relates to systems and methods for increased accessibility of transaction machines.

### BACKGROUND OF THE INVENTION

Transaction machines, such as vending machines, Automated Teller Machines (ATMs), ticket vending machines, self-service kiosks, and other similar types of machines, have become integral to our daily lives. Such transaction machines provide access to a wide variety of good and services ranging from product dispensing to financial transactions without direct interaction with an employee or worker to for such goods and services. However, user interfaces of transaction machines of the prior art do not provide for accessibility of user interfaces for those that may not be able to reach the standard height of the user interface of a typical transaction machine. For example, users of shorter stature, minors, those in wheelchairs, and users with other physical limitations may not be able to access a user interface at a fixed height of the typical prior art transaction machines.

The interfaces of the transaction machines of the prior art have failed to mitigate the inaccessibility of the user interfaces for users that have a height or reach that deviates from the fixed height of the prior art user interfaces, which may render such prior art transaction machines inaccessible to some users. The prior art has failed to address the problem of inaccessibility due to fixed height of the user interfaces of transaction machines. Therefore, there is a need for a transaction machine and user interface that provides for increased accessibility of the user interface in regard to height and reach of users.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, some embodiments of the present invention are related to a transaction system. The system may comprise a main body member and a user interface body member. The main body member may hold an inventory of goods that may be dispensed. The user interface body member may be mounted to the main body member. The user interface body member may include a user interface, a controller, a detection unit, and an actuation member. The user interface may be carried by the user interface body member and may be operable to facilitate transactions and dispense the goods responsive to the transaction. The controller may be in communication with the user interface. The detection unit may be in communication with the controller. The actuation member may be in communication with the controller and with the user interface. The user interface may be moveable between a raised position and a lowered position. The detection unit may include a height detection sensor that may sense a height of a user. The detection unit may be operable to transmit a height detection signal to the controller. The actuation member may be operable to move the user interface between the raised position and the lowered position responsive to the height detection signal.

The system may also include one or more of input member(s) that may be carried by the user interface body member and may be in communication with the controller. The input member(s) may be operable to generate an input height signal. The actuation member may be operable to move the user interface between the raised position and the lowered position responsive to the input height signal.

Input member(s) may be defined by a first input member and a second input member. The input height signal may be defined by a first input height signal that may be generated by operation of the first input member and a second input height signal that may be generated by operation of a second input member. The actuation member may be operable to move the user interface towards the raised position responsive to the first input height signal and towards the lowered position responsive to the second input height signal. The input height signal may be assigned a priority over the height detection signal.

The detection unit may also include a proximity sensor that may sense a proximity distance of the user which may be relative to the user interface. The proximity sensor may be operable to transmit a proximity signal to the controller. The actuation member may be operable to move the user interface between the raised position and the lowered position responsive to the proximity signal and to the height detection signal.

The actuation member may be operable to move the user interface to a reset position once the controller determines that a predetermined amount of time has passed since the height detection signal was transmitted by the detection unit. The reset position may be predetermined and programmable.

The user interface may be operable to transmit a completed transaction signal to the controller responsive to a transaction being completed using the user interface. Upon receipt of the completed transaction signal, one or more of the inventory of goods may be released to be dispensed from the main body member to a dispensing area. The dispensing area may be carried by the user interface body member so that the dispensing area may be moveable between the raised position and the lowered position as the user interface is moved between the raised position and the lowered position. The user interface may include a transaction interface that may be operable to communicate with a user device to conduct the transaction.

Some embodiments of the present invention are related to a user interface body member that may be mounted on a main body member of a transaction system. The user interface body member may comprise a user interface, a controller, a detection unit, and an actuation member. The user interface may be operable to facilitate transactions and dispense at least one of an inventory of goods carried by the main body member responsive to the transaction. The controller may be in communication with the user interface. The detection unit may be in communication with the controller. The actuation member may be in communication with the controller and the user interface. The user interface may be moveable between a raised position and a lowered position. The detection unit may include a height detection sensor that may sense a height of a user. The detection unit may be operable to transmit a height detection signal to the controller. The actuation member may be operable to move the user interface between the raised position and the lowered position responsive to the height detection signal.

The user interface body member may also include one or more input member(s) that may be in communication with the controller. The input member(s) may be operable to generate an input height signal. The actuation member may be operable to move the user interface between the raised position and the lowered position responsive to the input height signal.

The input member(s) may be defined by a first input member and a second input member. The input height signal may be defined by a first input height signal that may be generated by operation of the first input member and a second input height signal that may be generated by operation of the second input member. The actuation member may be operable to move the user interface towards the raised position responsive to the first input height signal and towards the lowered position responsive to the second input height signal. The input height signal may be assigned a priority over the height detection signal.

The detection unit may include a proximity sensor that may sense a proximity distance of the user relative to the user interface. The proximity sensor may be operable to transmit a proximity signal to the controller. The actuation member may be operable to move the user interface between the raised position and the lowered position responsive to the proximity signal and to the height detection signal.

The actuation member may be operable to move the user interface to a reset position once the controller determines that a predetermined amount of time has passed since the height detection signal was transmitted by the detection unit. and The reset position may be predetermined and programmable.

The user interface body member may also include a dispensing area. The user interface may be operable to transmit a completed transaction signal to the controller responsive to the transaction being completed using the user interface. Upon receipt of the completed transaction signal, one or more of the inventory of goods may be released to be dispensed from the main body member to the dispensing area. The dispensing area may be moveable between the raised position and the lowered position as the user interface may be moved between the raised position and the lowered position. The user interface may include a transaction interface that may be operable to communicate with a user device to conduct the transaction.

A method aspect of some embodiments of the present invention may be directed to a method of dispensing one or more of a good from a transaction system. The transaction system may comprise a main body member that may be configured to hold an inventory of goods and a user interface body member that may be mounted to the main body member. The method may include sensing a height of a user, transmitting a height detection signal, and operating an actuation member. The height of the user may be sensed using a detection unit that may be in communication with a controller which may be in communication with a user interface that may be carried by the user interface body member. The height detection signal may be transmitted to the controller. The actuation member may be operated in communication with the controller and the user interface to move the user interface between a raised position and a lowered position.

The method may also include generating an input height signal which may include a first input height signal generated by operating a first input member and a second input height signal generated by operating a second input member. The method may yet also include operating the actuation member to move the user interface towards the raised position responsive to the first input height signal and towards the lowered position responsive to the second input height signal. The input height signal may be assigned a priority over the height detection signal.

The method may also include sensing a proximity distance of the user relative to the user interface using a proximity sensor. The method may yet also include transmitting a proximity signal to the controller. The method may further include operating the actuation member to move the user interface between the raised position and the lowered position responsive to the proximity signal and to the height detection signal. The method may yet further include operating the actuation member to move the user interface to a reset position that may be based upon determining that a predetermined amount of time has passed since the height detection signal was transmitted to the controller. The method may also include programming the reset position.

### BRIEF DESCRIPTION OF THE DRAWINGS

Some embodiments of the present invention are illustrated as an example and are not limited by the figures of the accompanying drawings, in which like references refer to like elements.

FIG. 1 is a schematic diagram of a transaction system according to an embodiment of the present invention with a user interface body member mounted on the main body member of the system.

FIG. 2 is another schematic diagram of the transaction system according to FIG. 1.

FIG. 3 is another schematic diagram of the transaction system according to FIG. 1, shown in communication with a user device and interacting with a user.

FIG. 4 is another schematic diagram of the transaction system according to FIG. 2, shown with connections/communications of various components.

FIG. 5 is a schematic diagram of a transaction system according to an embodiment of the present invention with a user interface body member mounted on the main body member of the system that does not have a viewing window.

FIG. 6 is another schematic diagram of the transaction system according to FIG. 5.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a transaction system 1000 and/or a user interface body member 1002 that may be configured to be mounted on and/or caried by a transaction system 1000, to provide increased accessibility for user to conduct transactions with the transaction system 1000 and/or the user interface body member 1002 by having a moveable user interface 1003 that may facilitate transactions and may be moveable relative to the user interface body member 1002. The transaction system 1000 may, for example, and without limitation, resemble that of a vending machine, automatic teller machine, ticket machine, good dispensing machine, or any other transaction machine that may facilitate transactions for goods and/or services as may be understood by those who may have skill in the art. The user interface body member 1002 and the user interface 1003 may, for example, and without limitation, resemble that of a portion or more of afront face and/or user interface of a vending machine, automatic teller machine, ticket machine, good dispensing machine, or any other transaction machine that may facilitate transactions for goods and/or services as may be understood by those who may have skill in the art.

For the purposes of the description of the present invention, the use of the word “goods” or “good” should be understood to refer to either or both of goods and/or services either individually or in combination as may be understood by those who may have skill in the art.

The transaction system 1000 may include a main body member 1001 that may be configured to hold an inventory 1004 of goods 1006 that may be dispensed responsive to a transaction. The user interface body member 1002 may be mounted on and/or caried by a transaction system 1000 and/or the main body member 1001 of the transaction system 1000. A user interface 1003 may be mounted on, carried by, and/or moveably attached to the user interface body member 1002. The user interface 1003 may be operable to facilitate transactions and may dispense goods responsive to the transaction. The user interface 1003 may be moveable between a raised position and a lowered position. The movement of the user interface 1003 between the raised position and the lowered position may be via an actuation member 2004. A controller 4002 may be utilized to control the actuation member 2004 to move the user interface 1003 between the raised position and the lowered position. The controller 4002 may control the actuation member 2004 to move the user interface 1003 between the raised position and the lowered position based on and/or responsive to a signal received from a detection unit 1018. The detection unit 1018 may be configured to sense and/or detect a height and/or proximity of a user and/or potential user of the transaction system 1000/user interface 1003 relative to the detection unit 1018, the main body member 1001, the user interface body member 1002, and/or the user interface 1003.

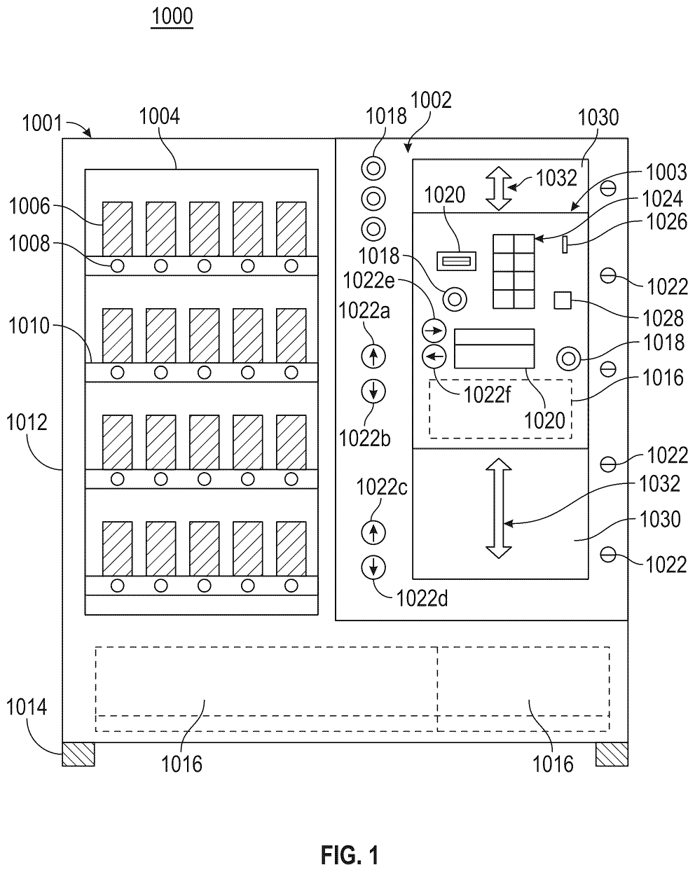

Initially referring to FIGS. 1-2 and 5-6, the structure, features, functions, and/or aspects of various embodiments according to the present invention may now be further detailed. Some embodiments of the present invention may be directed to a transaction system 1000 having a main body member 1001, a user interface body member 1002, and a user interface 1002. Some embodiments of the present invention may be directed to a user interface body member 1002 configured to be mounted to and/or carried by a main body member 1001 of a transaction system 1000. In some embodiments of the present invention, the user interface body member 1002 may be hingedly attached to and/or hingedly mounted on the main body member 1001 such that the user interface body member 1002 may be opened and closed as a door to an interior area of the main body member 1001. Although it may not be illustratively shown in the figures, it is contemplated that the user interface body member 1002 may comprise the entire frontal face of a transaction system 1000, such that the user interface body member 1002 may be a retrofitted to preexisting transaction machines and/or transaction systems 1000 to replace the frontal face of the preexisting transaction machine and/or transaction system 1000. The user interface body member 1002 may also be sized to be retrofitted to replace a portion of the frontal face of preexisting transaction machines and/or transaction systems 1000.

The main body member 1001 may be configured to hold an inventory 1004 of goods 1006 to be dispensed. A user interface 1003 may be mounted to, carried by, attached to, moveably mounted to, moveably carried by, and/or moveably attached to the user interface body member 1002. The user interface 1003 may be operable to facilitate transactions, and the user interface 1003 may be operable to dispense goods responsive to a transaction. Embodiments may include an actuation member 2004 in communication with the user interface 1003. The actuation member 2004 may be carried by and/or mounted within the user interface body member 1002, and the actuation member 2004 may be connected to the user interface 1003 and/or to a rearward portion of the user interface 1003. The user interface 1003 may be moveable between a raised position and a lowered position. The user interface 1003 may be moveable between a raised position and a lowered position via the actuation member 2004.

The raised position of the user interface 1003 may be defined as when the user interface 1003 is positioned adjacent to an upper portion of the user interface body member 1002. The lowered position of the user interface 1003 may be defined as when the user interface 1003 is positioned adjacent to a lower portion of the user interface body member 1002 and/or positioned closer to a lower portion of the user interface body member 1002 than to the upper portion of the user interface body member 1002. Some embodiments of the present invention may include a user interface channel 1030. The user interface channel 1030 may be extended into and along a frontal portion of the user interface body member 1002. The user interface channel 1030 may have a height that is greater than a width of the user interface channel 1030. The width of the user interface channel 1030 may be greater than and/or about equal to a width of the user interface 1003, such that the sides of the user interface channel 1030 may not interfere with the movement of the user interface 1002 between the raised position and the lowered position. The raised position of the user interface 1003 may be defined as when the user interface 1003 is positioned adjacent to an upper portion of the user interface channel 1030, and the lowered position of the user interface 1003 may be defined as when the user interface 1003 is positioned adjacent to a lower portion of the user interface channel 1030.

The actuation member 2004 may be configured and/or operable to move the user interface 1003 between the raised position and the lowered position responsive to a detection signal received, such as, and without limitation, a height detection signal and/or a proximity signal. The actuation member 2004 may also be configured and/or operable to be selectively controlled to move the user interface 1003 between the raised position and the lowered position. The actuation member 2004 may comprise, without limitation, one or more of a screw actuator, a linear chain actuator, a column linear actuator, a motor, a servo, a stepper motor, a solenoid, a chain drive, a belt drive, a screw drive, a side mount motor, and any combination or combinations thereof. Some preferred embodiments of the present invention may include an actuation member 2004 that comprises a screw actuator and/or a screw drive.

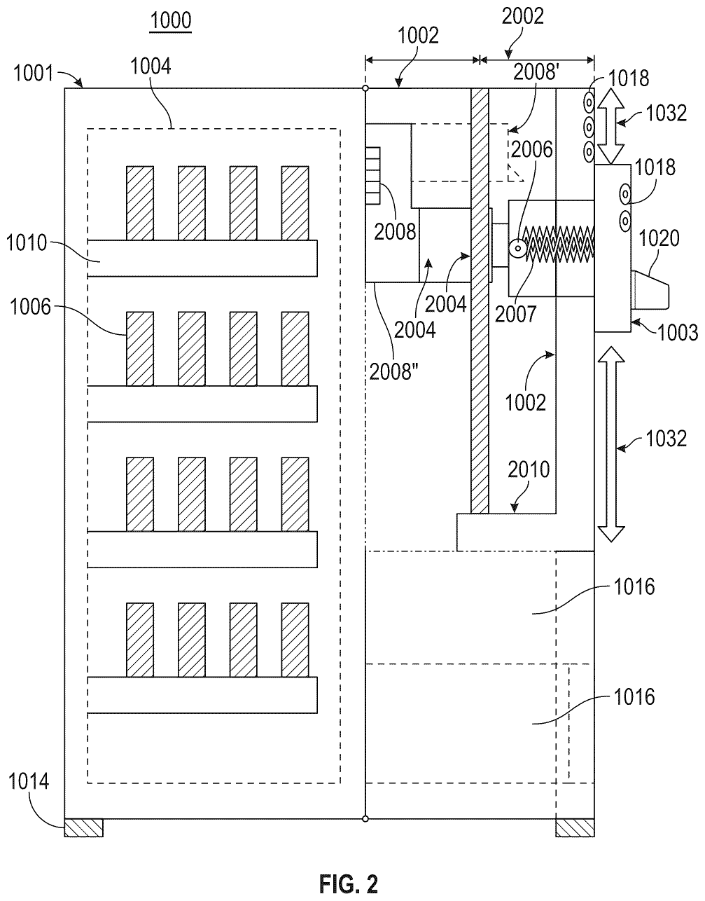

The transaction system 1000 and/or the main body member 1001 of the transaction system 1000 may include one or more of various components such as a shelf 1010, a goods indicator 1008, a dispensing area 1016, one or more of a foot 1014, and/or a goods obtainer 2008, 2008′, 2008″. One or more feet 1014 may be positioned at a lower portion of the transaction system 1000, the main body member 1001, and/or the user interface body member 1002. The feet 1014 may comprise supports, however, in some embodiments of the present invention one or more of the feet 1014 may comprise rollers and/or castors. As illustratively shown in FIGS. 1-2, the transaction system 1000, the main body member 1001, and/or the inventory 1004 of goods 1006 may include multiple shelves 1010 which may be utilized to carry and/or display goods 1006 held for dispensing upon and/or responsive to a transaction. Those skilled in the art may notice and appreciate that the goods 1006 and/or the inventory 1004 of goods 1006 may comprise any goods to be dispensed upon and/or responsive to a transaction while still accomplishing all the goals, features, and advantages of the present invention. For example, without limitation, the goods 1006 may comprise one or more of consumables, food, beverages, first aid items, produce, candy, toys, tickets, clothing, decoration, and any other good that may be dispensed from, with, and/or via a transaction machine as may be understood by those who may have skill in the art.

The transaction system 1000, main body member 1001, user interface body member 1002, and/or the inventory 1004 may include a window to view the goods 1006 of the inventory 1004 and/or to view the goods 1006 held/carried by the main body member 1001. The window may comprise a semi-transparent material and/or transparent material to allow for the goods 1006 to be viewed from outside the main body member 1001, the transaction system 1000, and/or the user interface body member 1002. However, it is contemplated that the window may also comprise a display that may be operable to display a live video image of the goods 1006 carried by the main body member 1001 and/or may be operable to display a prerecorded depiction and/or imagery of goods 1006. The display may also be configured to display advertisement materials, such as advertisement banners or advertisement videos for goods and/or services.

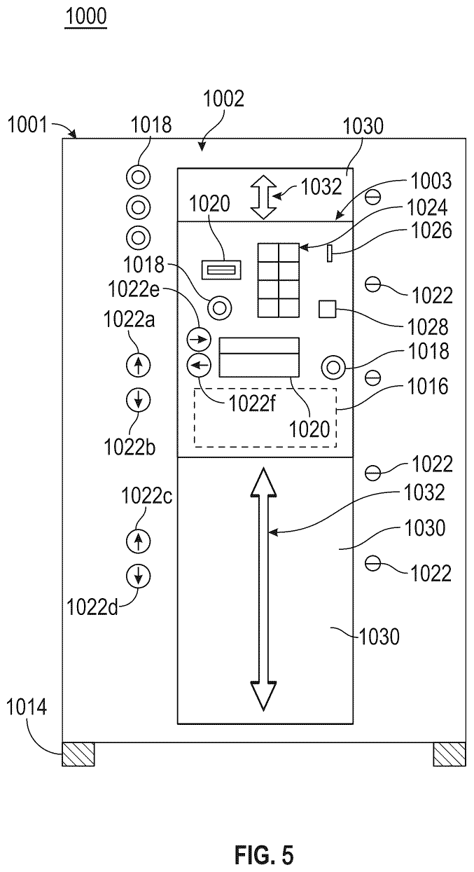

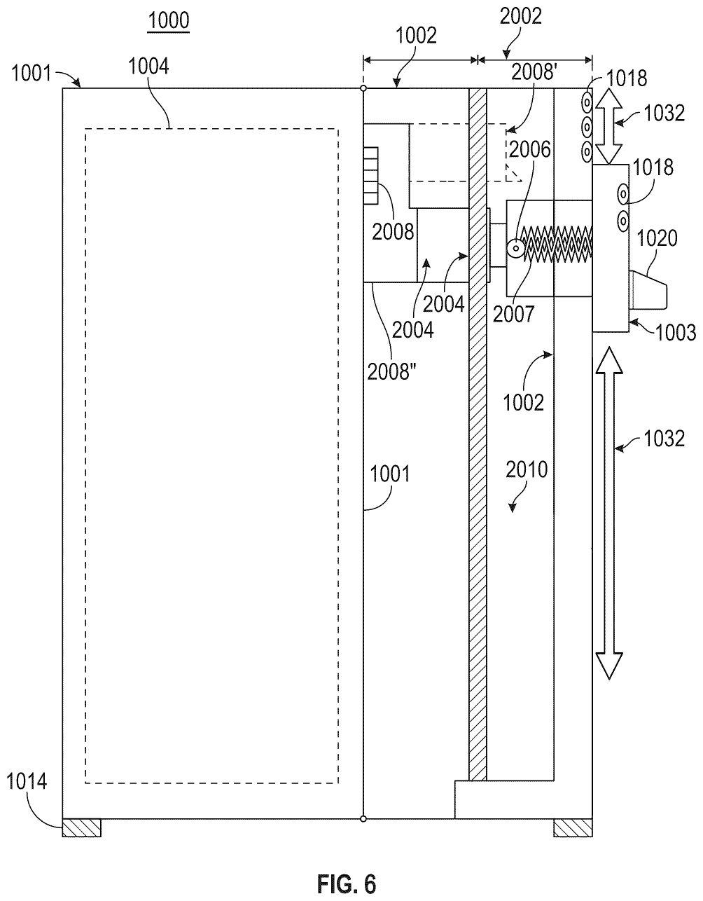

Also, some embodiments of the present invention, the transaction system 1000, main body member 1001, user interface body member 1002, and/or the inventory 1004 may not include a window to view the goods 1006 of the inventory 1004 and/or to view the goods 1006 held/carried by the main body member 1001, as illustrated in FIGS. 5 and 6. In these embodiments of the present invention, the user interface body 1002 may be shaped to be mounted and/or carried by the main body member 1001 such that the user interface body 1002 may comprise the entire frontal face of the transaction system 1000 when the user interface body 1002 is mounted and/or carried by the main body member 1001.

In some embodiments of the present invention, the inventory 1004 of goods 1006 may instead comprise an arrangement of goods 1006 carried therein that may be each be carried by a respective hold and release mechanism which may hold one or more of the goods 1006 and release one or more of the goods 1006 responsive and/or upon the completion of the transaction. For example, without limitation, the inventory 1004 may carry the goods in a spiral pattern via hold and release mechanisms operable to hold the goods 1006 within the inventory 1004 and may be operable to release one or more of the goods 1006 responsive and/or upon the completion of a transaction.

The goods indicator(s) 1008 may be positioned adjacent to one or more goods 1006 carried/held by the main body member 1001. The goods indicator 1008 may also be positioned on one of the shelves 1010. The goods indicator 1008 may display information regarding the goods 1006. For example, without limitation, the goods indicator 1008 may display a name, price, indicator label, quantity, date, and/or availability of goods 1006 that the goods indicator 1008 may be associated with and/or positioned adjacent to.

The dispensing area 1016 may be positioned on a portion of the main body member 1001, the user interface body member 1002, and/or the user interface 1003. The dispensing area 1016 may be operable to allow for one or more goods 1006 to be accessed, obtained, and/or retrieved from the main body member 1001 upon and/or responsive to a transaction. The goods obtainer 2008, 2008′, 2008″ may be carried by, mounted to, moveably carried by, and/or moveably mounted to an interior portion of the main body member 1001, the user interface body member 1002, the user interface 1003, and/or the actuation member 2004. The goods obtainer 2008, 2008′, 2008″ may be operable to grasp, move, and/or dispense goods 1006 to the dispensing area 1016 upon and/or responsive to a transaction.

In some embodiments of the present invention, the goods obtainer 2008, 2008′, 2008″ and/or the dispensing area 1016 may include a chute portion. The chute portion may comprise an insulated material, and may comprise a material resistant to scratches, dents, punctures, welts, cracks, and/or rips that may have been caused by the goods 1006 moving between the inventory 1004 of goods 1006 and the dispensing area 1016 via the chute portion of the goods obtainer 2008, 2008′, 2008″ and/or the dispensing area 1016. In some embodiments of the present invention, the dispensing area 1016 may include an access panel that may be operable to allow access to an interior area of the dispensing area 1016 such that goods 1006 in the interior area of the dispensing area 1016 may be accessed, obtained, and/or retrieved therefrom, which may follow the completion of the transaction. The access panel may comprise an insulated material, and the access panel may comprise a material such as, without limitation, one or more of silicone, Polyvinyl Chloride (PVC), Acrylonitrile Butadiene Styrene (ABS), Polycarbonate (PC), Polyethylene (PE), Polypropylene (PP), vinyl, and/or Thermoplastic Elastomer (TPE). In some preferred embodiments of the present invention, the access panel may comprise a silicone material.

In some embodiments of the present invention, the goods obtainer 2008, 2008′, 2008″ may move in unison with the user interface 1003 when the goods obtainer 2008, 2008′, 2008″ is being operated to grasp, move, and/or dispense good 1006 to the dispensing area 1016. Although it is not illustratively shown in the figures, it is contemplated that one or more of a goods obtainer 2008, 2008′, 2008″ may be positioned adjacent to one or more of the goods 1006 held/carried by the main body member 1001, such as, without limitation, a goods obtainer 2008, 2008′, 2008″ may be positioned on each shelf 1010 such that the goods obtainer 2008, 2008′, 2008″ may operate to move and/or push a good 1006 to be dispensed to a dispensing area 1016. Examples of the goods obtainer 2008, 2008′, 2008″ include, without limitation, a claw, a robotic arm, a clutch device, a turn screw, an auger, a piston, an actuator, a step motor, a goods catcher, and/or any other component that may be utilized as goods obtainer 2008, 2008′, 2008″ to grasp, move, and/or dispense goods to a dispensing area 1016 as may be understood by those who may have skill in the art.

In some embodiments of the present invention, the main body member 1002 may include an actuator support 2010. The actuation member 2004 may have a lower portion carried by and/or mounted on the actuator support 2010, and the actuation member 2004 may be vertically extending between the actuator support 2010 and an upper interior portion of the main body member 1001 and/or of the user interface body member 1002.

Some embodiments of the present invention may include an extension unit 2006, 2007. The extension unit 2006, 2007 may be carried by the actuation member 2004, the user interface body member 1002, and/or the user interface 1003. The extension unit 2006, 2007 may be positioned extending between the actuation member 2004 and an interior portion of the user interface 1003. The extension unit 2006, 2007 may be configured and/or operable to move the user interface 1003 between a retracted position and an extended position. The retracted position of the user interface 1003 may be defined as when the user interface is proximately adjacent to the user interface body member 1002. The extended position of the user interface 1003 may be defined as when the user interface 1003 is extended a distance away from the user interface body member 1002. The extension unit 2006, 2007 may be configured and/or operable to move the user interface 1003 between the retracted position and the extended position upon and/or responsive to a detection signal received, such as, and without limitation, a height detection signal and/or a proximity signal. The extension unit 2006, 2007 may also be configured and/or operable to be selectively controlled to move the user interface 1003 between the retracted position and the extended position.

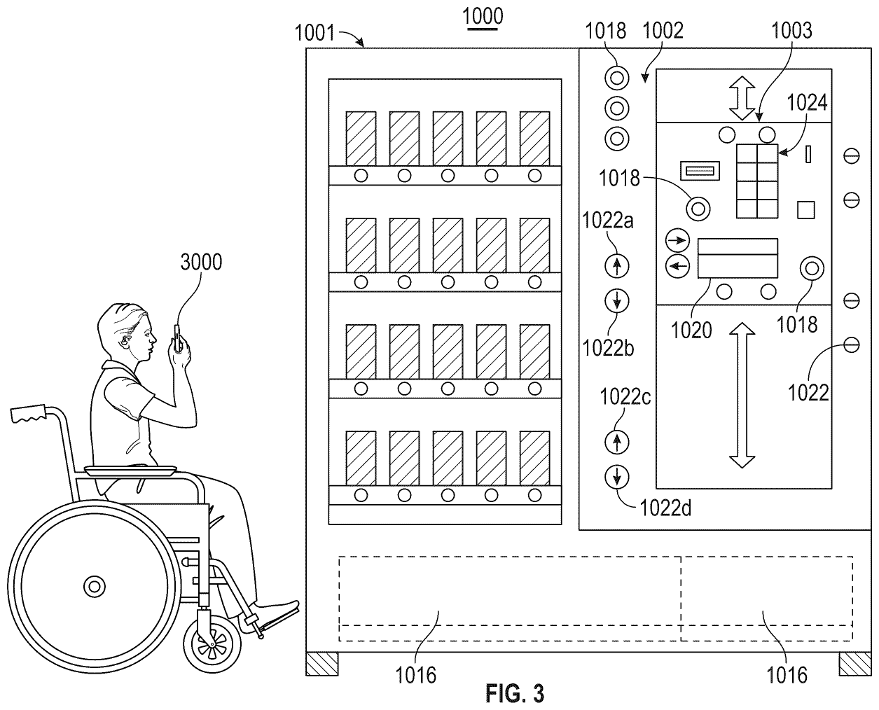

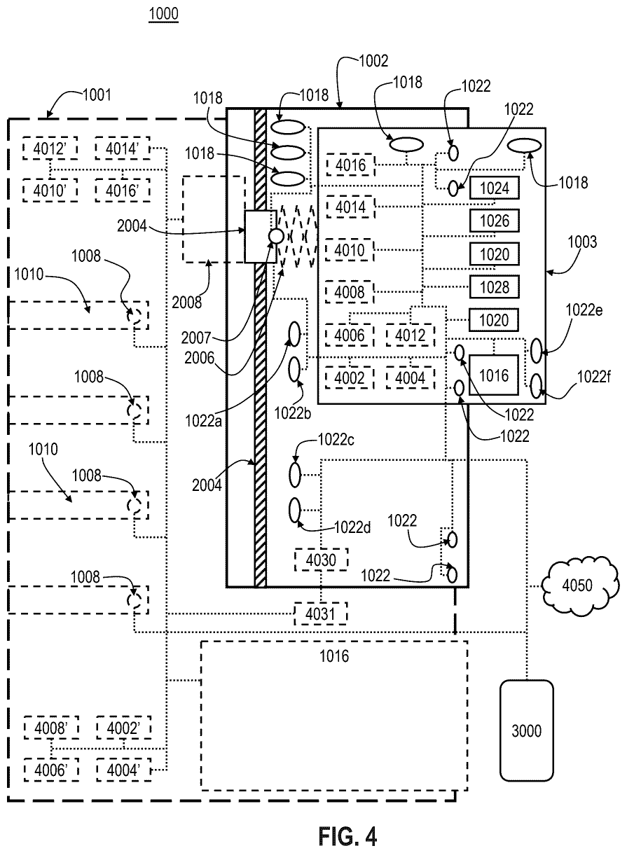

Now referring to FIGS. 1-6, the electronic and/or powered components of some embodiments of the present invention may now be described. Some embodiments of the present invention may include one or more of a controller 4002, 4002′ a network unit 4004, 4004′ a datastore 4006, 4006′ a power unit 4008, 4008′ and/or an imputation unit 4012, 4012′. Also, some embodiments of the present invention may also include one or more of a detection unit 1018, a transaction component 1020, an input member 1022, a transaction interface 1024, an indicator 1026, and/or a transaction operator 1028. Furthermore, some embodiments of the present invention may include one or more of a communication access 4010, 4010′ a speaker 4014, 4014′ a microphone 4016, 4016′ a network 4050, a user device 3000, and/or communication harnesses 4030, 4031.

The controller 4002 may be carried by one or more of the user interface body member 1002 and/or the user interface 1003. Some embodiments of the present invention may also, and/or alternatively, comprise a controller 4002′ that may be carried by the transaction system 1000 and/or the main body member of the transaction system 1000. For example, and without limitation, embodiments of the present invention may include one of, or both, a controller 4002 and a controller 4002′. For the purposes of the description of the present invention, the use of the terms “controller 4002,” “controller 4002′,” and “controller 4002, 4002′,” may be used interchangeably and should be understood to refer to the controller 4002 and/or the controller 4002′ individually or in combination without any express limitation or limitation implied thereby. For another example, without limitation, embodiments of the present invention may include a controller 4002 carried by one or more of the user interface body member 1002 and/or the user interface 1003, and/or embodiments of the present invention may also/alternatively include a controller 4002′ carried by the transaction system 1000 and/or the main body member of the transaction system 1000.

The controller 4002 may be in communication with one or more of the powered components of an embodiment of the present invention. For the purposes of the description of the present invention, the use of the terms “powered components,” “powered components of the present invention,” and/or “powered components of an embodiment of the present invention,” should be understood to mean one or more of the main body member 1001, the user interface body 1002, the user interface 1003, the goods indicator(s) 1008, the shelf/shelves 1010, the dispensing area 1016, the detection unit(s) 1018, the transaction component 1020, the input member(s) 1022, the transaction interface 1024, the indicator 1026, the transaction operator 1028, the actuation member 2004, the extension unit 2006, 2007, the goods obtainer 2008, 2008′, 2008″, the controller 4002, 4002′, the network unit 4004, 4004′, the datastore 4006, 4006′, the power unit 4008, 4008′, the communication access 4010, 4010′, the imputation unit 4012, 4012′, the speaker 4014, 4014′, the microphone 4016, 4016′, the communication harness 4030, the communication harness 4031, a network 4050, and a user device 3000, individually, in entire combination, and/or in any combination/combinations thereof without any express limitation or limitation implied thereby.

The controller 4002 may be utilized to receive, send, transceive, read, write, compute, execute, analyze, manage, process, run, and/or control machine readable information, code, data, executables, commands, programs, signals, and/or transmissions as may be understood by those who may have skill in the art. The controller 4002 may be operable to monitor, manage, and/or control one or more of the powered components of an embodiment of the present invention. Examples of the controller 4002 include, without limitation, one or more of a central processing unit (CPU), a graphics processing unit (GPU), a microcontroller (MCU), a field-programmable gate array (FPGA), a non-field-programmable gate array (NFPGA), a co-processor, an audio/sound processor, a digital signal processor, an application specific integrated circuit (ASIC), an embedded processor, a system-on-a-chip (SoC), a neural processing unit (NPU), an advanced RISC machine (ARM) processor, and/or any combination or combinations thereof and/or any other component that may be utilized as the controller 4002 as may be understood by those who may have skill in the art. Further details on the controller 4002 follows below.

The network unit 4004, 4004′ may be in communication with one or more of the powered components, such as, and without limitation, the controller 4002, the datastore 4006, 4006′, the power unit 4008, 4008′, the network 4050, and/or the user device 3000. Embodiments of the present invention may include a network unit 4004 carried by the user interface body member 1002 and/or the user interface 1003, and embodiments of the present invention may include a network unit 4004′ carried by the transaction system 1000 and/or the main body member 1001 of the transaction system 1000. However, it should be understood that the terms network unit 4004 and network unit 4004′ may be used interchangeably, to refer to themselves individually, and/or to refer to one another in combination, and without imitation. The network unit 4004 may be utilized to facilitate, bridge, and/or allow communication between one or more of the powered components and another one or more of the powered components such as, the network 4050 and/or the user device 3000. The network unit 4004 may be utilized to facilitate, bridge, allow, read, write, send, receive, transceive, translate, compute, relay, and/or transmit machine readable information, code, data, executables, commands, programs, signals, and/or transmissions as may be understood by those who may have skill in the art. Examples of the network unit 4004 include, without limitation, a network card, an antenna, a router, a modem, a hub, a switch, a receiver, a transceiver, and/or any other component that may be used as the network unit 4004 as may be understood by those who may have skill in the art, and any combination and/or combinations thereof.

The datastore 4006, 4006′ may be in communication with one or more of the powered components, such as, and without limitation, the controller 4002, the network unit 4004, the power unit 4008, 4008′, the network 4050, and/or the user device 3000. Embodiments of the present invention may include a datastore 4006 carried by the user interface body member 1002 and/or the user interface 1003, and embodiments of the present invention may include a datastore 4006′ carried by the transaction system 1000 and/or the main body member 1001 of the transaction system 1000. However, it should be understood that the terms datastore 4006 and datastore 4006′ may be used interchangeably, to refer to themselves individually, and/or to refer to one another in combination, and without imitation. The datastore 4006 may be utilized to receive, send, transceive, read, write, translate, store, manage, and/or index machine readable information, code, data, executables, commands, programs, signals, and/or transmissions as may be understood by those who may have skill in the art. Examples of the datastore 4006 include, without limitation, one or more of a hard drive, a disk drive, a solid state drive, a compact disk/disc, a disk/disc drive, a floppy disk/disc, a floppy disk/disc drive, a flash memory, a random access memory, a non-random access memory, non-volatile computer-readable memory, a volatile computer-readable memory, cloud memory, a cloud storage, a server center, virtual memory, cache memory, and/or any combination/combinations thereof and/or any other component that may be used as the datastore 4006 as may be understood by those who may have skill in the art.

The power unit 4008, 4008′ may be in communication with one or more of the powered components. Embodiments of the present invention may include a power unit 4008 carried by the user interface body member 1002 and/or the user interface 1003, and embodiments of the present invention may include a power unit 4008′ carried by the transaction system 1000 and/or the main body member 1001 of the transaction system 1000. However, it should be understood that the terms power unit 4008 and power unit 4008′ may be used interchangeably, to refer to themselves individually, and/or to refer to one another in combination, and without imitation. The power unit 4008 may be utilized to receiver, provide, relay, regulate, manage, monitor, transform, and/or control power (such as electrical power) to the one or more powered components that the power unit 4008 may be in communication therewith. Examples of the power unit 4008 include, without limitation, a power brick, a power regulator, a transformer, a rectifier, a voltage regulator, an amperage regulator, a signal generator, an inverter, a power storage, a battery, a power outlet connector/plug, and any combination or combinations thereof and any other power supply/power component that may be used as/for the power unit 4006 as may be understood by those who may have skill in the art.

The communication access 4010, 4010′ may be in communication with one or more of the powered components, such as, and without limitation, the controller 4002, the network unit 4004, the datastore 4006, the power unit 4008, and/or the network 4050. The communication access 4010, 4010′ may be removably/reversibly in communication with one or more of an operator device to allow for the operator device to perform management, maintenance, repairs, and/or updates to the powered components such as, and without limitation, the controller 4002, the network unit 4004, the datastore 4006, the power unit 4008, the speaker 4014, and/or the microphone 4016. Examples of the input unit 4014, 4012′ include, without limitation, one or more of a communication port/line, a universal serial bus (USB) port/line, a serial ATA (SATA) communication port, a data communication port/line, a wireless communication device, and any combination or combinations thereof and any other component that may be used as/for the communication access 4010, 4010′ as may be understood by those who may have skill in the art.

The imputation unit 4012, 4012′ may be in communication with one or more of the powered components, such as, and without limitation, the controller 4002, the network unit 4004, the datastore 4006, the power unit 4008, and/or the network 4050. The imputation unit 4012, 4012′ may be utilized to allow for the operator device to perform management, maintenance, repairs, and/or updates to the powered components such as, and without limitation, the controller 4002, the network unit 4004, the datastore 4006, the power unit 4008, the speaker 4014, and/or the microphone 4016. The imputation unit 4012, 4012′ may comprise an interface configured to register inputs made thereon, and a display to display data and/or information. Examples of the input unit 4014, 4012′ include, without limitation, one or more of a display screen, a touch-screen display, a keyboard, one or more buttons, switches, knobs, dials, levers, tracking mouse, and any combination or combinations thereof and any other component that may be used as/for the imputation unit 4012, 4012′ as may be understood by those who may have skill in the art.

The speaker 4014, 4014′ may be in communication with one or more of the powered components. Embodiments of the present invention may include one or more of a speaker 4014 carried by the user interface body member 1002 and/or the user interface 1003, and embodiments of the present invention may include one or more of a speaker 4014′ carried by the transaction system 1000 and/or the main body member 1001 of the transaction system 1000. However, it should be understood that the terms speaker 4014, speakers 4014, speaker 4014′, and speakers 4014′ may be used interchangeably, to refer to themselves individually, in entirety, and/or in any combination or combinations thereof without imitation. The speaker 4014 may be utilized to emit audio sounds. The speaker 4014 may also be configured to emit audio sounds responsive to an audio signal received by the speaker 4014 and/or the speaker 4014 may be configured to convert/translate audio signal(s) received by the speaker 4014 into audio sounds emitted by the speaker 4014. The speaker 4014 may comprise any one or more devices/components that may be used as the speaker 4014 to emit audio sounds as may be understood by those who may have skill in the art.

The microphone 4016, 4016′ may be in communication with one or more of the powered components. Embodiments of the present invention may include one or more of a microphone 4016 carried by the user interface body member 1002 and/or the user interface 1003, and embodiments of the present invention may include one or more of a microphone 4016′ carried by the transaction system 1000 and/or the main body member 1001 of the transaction system 1000. However, it should be understood that the terms microphone 4016, microphones 4016, microphone 4016′, and microphones 4016′ may be used interchangeably, to refer to themselves individually, in entirety, and/or in any combination or combinations thereof without imitation. The microphone 4016 may be utilized to sense, detect, register, record, and/or receive audio sounds such as noises and voices, and the microphone 4016 may be configured to translate and emit a sensed audio signal based on and/or responsive to audio sounds sensed, detected, registered, recorded, and/or received by the microphone 4016. The microphone 4016 may comprise any one or more devices/components that may be used as the microphone 4016 to sense, detect, register, record, and/or receive audio sounds and emit a sensed audio signal based on and/or responsive to audio sounds sensed, detected, registered, recorded, and/or received by the microphone 4016 as may be understood by those who may have skill in the art.

The network 4050 may be in communication with and/or connectable in communication with one or more of the powered components, such as, and without limitation, the controller 4002, the network unit 4004, the datastore 4006, and/or the user device 3000. The network 4050 may be utilized to facilitate, allow, control, and/or manage communication such as, and without limitation, machine-readable communication, between one or more of the powered components and another one or more of the powered components. For example, and without limitation, communication between one or more of the powered components and another one or more of the powered components may be allowed and/or facilitated via the network 4050. Examples of the network 4050 include, a wireless network, a wired network, a server center, a communication tower, a world-wide network, a cellular network, satellite communication, a Bluetooth connection, a wireless fidelity connection, a router, a modem, a communication hub, radio communication, near-field communication, and any combination and/or combinations thereof and any other network or device that may be used as the network 4050 as may be understood by those who may have skill in the art.

Some embodiments of the present invention may include a communication harness 4030 carried by the user interface body member 1002 and/or by the user interface 1003. The main body member 1001 may also carry another communication harness 4031. The communication harnesses 4030, 4031 may be engaged in communication with one another to allow and/or facilitate communication and/or power transmission between the powered components that may be carried by the main body member 1001 and the powered components that may be carried by the user interface body member 1002 and/or the user interface 1003. Those skilled in the art may notice and appreciate that a preexisting transaction machine and/or transaction system 1000 that includes a communication harness 4031 may be more easily retrofitted with a user interface body member 1002 and user interface 1003 by engaging the communication interfaces 4030, 4031 with one another when the user interface body member 1002 is mounted, and/or is being mounted on, the main body member 1001. However, it is contemplated that embodiments of the present invention may include communication(s) between the powered components carried by the main body member 1001 and the powered components carried by the user interface body member 1002/user interface 1003 by other means besides via communication harnesses 4030, 4031.

Now referring to FIGS. 1 and 4-5, embodiments of the present invention may include one or more of a transaction component 1020, an input member 1022, a transaction interface 1024, an indicator 1026, and/or a transaction operator 1028. The transaction component 1020 may be carried by, mounted on, mounted to, and/or attached to the user interface 1003. The transaction component 1020 may be in communication with one or more of the powered components such as, and without limitation, the controller 4002, the network unit 4004, the power unit 4008, the network 4050, and/or the user device 3000. The transaction component 1020 may comprise a receptacle and/or dispenser of monetary notes, such as dollar bills. The transaction component 1020 may be configured to receive, intake, dispense, and/or eject monetary notes therein and/or therefrom responsive to a transaction. The transaction component 1020 may be configured to detect and/or determine the monetary amount of the monetary note received and/or dispensed by/from the transaction component 1020, and/or the transaction component 1020 may be configured to detect and/or determine if the monetary note is counterfeit or noncounterfeit. The transaction component 1020 may comprise any known transaction component used for receiving and/or dispensing monetary bills from transaction machines as may be understood by those who may have skill in the art.

Embodiments of the present invention may include one or more of an input member 1022. The input member(s) 1022 may be positioned on a frontal face of the user interface body member 1002, and the input member(s) 1022 may be positioned adjacent to the user interface 1003 and/or adjacent to the path of travel the user interface 1003 may take when the user interface 1003 moves between the raised position and the lowered position. The input member(s) 1022 maybe in communication with one or more of the powered components such as, and without limitation, the actuation member 2004, the extension unit 2006, 2007, the controller 4002, and/or the power unit 4008. The input member(s) 1022 may be operable to emit and/or generate an input height signal. The input member(s) 1022 may also be operable to emit and/or generate an input height signal upon the input member 1022 being activated and/or responsive to the input member 1022 being activated. The input member(s) 1022 may include, without limitation, one or more of a button, dial, switch, knob, touch-sensitive device, and any combination(s) thereof.

The input member(s) 1022 may be configured to emit and/or generate an input height signal that may be related to the position of the input member 1022 and/or the input member(s) 1022 may be configured to emit and/or generate an input height signal that may be related to the position of the user interface 1003.

For example, without limitation, the input member(s) 1022 may be configured to emit and/or generate an input height signal that may be related to the position of the input member 1022, and the input height signal may be received by one or more of the powered components, such as and without limitation, the controller 4002 and/or the actuation member 2004. Moreover, for example, and without limitation, based on and/or responsive to the input height signal received by the controller 4002 and/or the actuation member 2004, the controller 4002 and/or the actuation member 2004 may be operable and/or configured to move the user interface 1003 between the raised position and the lowered position, and may move the user interface 1003 to a position that may be adjacent to and/or associated with the input member 1022. More specifically, without limitation, the actuation member 2004 may be operable and/or configured to move the user interface 1003 between the raised position and the lowered position responsive to the input height signal, and may move the user interface 1003 to a position that may be adjacent to and/or associated with the input member 1022. Also and/or alternatively, without limitation, the controller 4002 may be operable and/or configured to, control and/or selectively control the actuation member 2004 to cause the actuation member 2004 to move the user interface 1003 between the raised position and the lowered position responsive to the input height signal, and may move the user interface 1003 to a position that may be adjacent to and/or associated with the input member 1022.

Some embodiments of the present invention may also and/or instead include other input members 1022a, 1022b, 1022c, 1022d (alternatively: input members 1022a-d) that may be configured and/or operable to emit and/or generate an input height signal that may be related to a direction of movement. The input members 1022a-d that may be configured and/or operable to emit and/or generate an input height signal that may be related to a direction of movement upon being activated and/or operated.

For example, without limitation, the input members 1022a, 1022c may be configured and/or operable to emit and/or generate an input height signal that may be related to a direction of movement for the user interface 1003 to be moved towards/to the raised position, and based on the input height signal, the actuation member 2004 may be operable to move the user interface 1003 towards/to the raised position and/or the controller 4002 may be operable to control and/or selectively control the actuation member 2004 to move the user interface 1003 towards/to the raised position. The user interface 1003 may be moved towards/to the raised position by the actuation member 2004 and/or by the controller 4002 so long as the input member 1022a, 1022c is being activated, and/or at an incremental distance for each time the input member 1022a, 1022c is activated (and/or for each time an input height signal from the input member 1022a, 1022c is received by the actuation member 2004 and/or by the controller 4002).

For another example, without limitation, the input members 1022b, 1022d may be configured and/or operable to emit and/or generate an input height signal that may be related to a direction of movement for the user interface 1003 to be moved towards/to the lowered position, and based on the input height signal, the actuation member 2004 may be operable to move the user interface 1003 towards/to the lowered position and/or the controller 4002 may be operable to control and/or selectively control the actuation member 2004 to move the user interface 1003 towards/to the lowered position. The user interface 1003 may be moved towards/to the lowered position by the actuation member 2004 and/or by the controller 4002 so long as the input member 1022b, 1022d is being activated, and/or at an incremental distance for each time the input member 1022b, 1022d is activated (and/or for each time an input height signal from the input member 1022b, 1022d is received by the actuation member 2004 and/or by the controller 4002).

Some embodiments of the present invention may also and/or alternative include other input members 1022, such as input members 1022e, 1022f. The input members 1022e, 1022f may be positioned on a frontal face of the user interface 1003 and/or on a frontal face of the user interface body member 1002. The input members 1022e, 1022f may be configured and/or operable to emit and/or generate an input extension signal, and the input members 1022e, 1022f may be configured and/or operable to emit and/or generate an input extension signal upon activation and/or responsive to being activated. The input extension signal may be related to a direction of movement away from and/or towards the user interface body member 1002, and/or the input extension signal may be related to a direction of movement away from and/or towards the main body member 1001.

For example, without limitation, the input member 1022e may be configured and/or operable to emit and/or generate an input extension signal that may be related to a direction of movement for the user interface 1003 to be moved towards/to the extended position, and based on the input extension signal, the extension unit 2006, 2007 may be operable to move the user interface 1003 towards/to the extended position and/or the controller 4002 may be operable to control and/or selectively control the extension unit 2006, 2007 to move the user interface 1003 towards/to the extended position. The user interface 1003 may be moved towards/to the extended position by the extension unit 2006, 2007 and/or by the controller 4002 so long as the input member 1022e is being activated, and/or at an incremental distance for each time the input member 1022e is activated (and/or for each time an input extension signal from the input member 1022e is received by the extension unit 2006, 2007 and/or by the controller 4002).

For another example, without limitation, the input member 1022f may be configured and/or operable to emit and/or generate an input extension signal that may be related to a direction of movement for the user interface 1003 to be moved towards/to the retracted position, and based on the input extension signal, the extension unit 2006, 2007 may be operable to move the user interface 1003 towards/to the retracted position and/or the controller 4002 may be operable to control and/or selectively control the extension unit 2006, 2007 to move the user interface 1003 towards/to the retracted position. The user interface 1003 may be moved towards/to the retracted position by the extension unit 2006, 2007 and/or by the controller 4002 so long as the input member 1022f is being activated, and/or at an incremental distance for each time the input member 1022f is activated (and/or for each time an input extension signal from the input member 1022f is received by the extension unit 2006, 2007 and/or by the controller 4002).

Some embodiments of the present invention may include a transaction interface 1024. The transaction interface 1024 may be carried by, mounted on, and/or mounted to the user interface 1003. The transaction interface 1024 may be in communication with one or more of the powered components, such as, and without limitation, the controller 4002, the power unit 4008, and/or a user device 3000. The transaction interface 1024 may be utilized to emit and/or generate one or more of a transaction interface input signal, and the transaction interface 1024 may be utilized to emit and/or generate one or more of a transaction interface input signal upon/responsive to the transaction interface 1024 being activated and/or operated. In some embodiments of the present invention, the transaction interface 1024 may be operable to communicate with a user device 300 to conduct transactions, and the transaction interface 1024 may be utilized to emit and/or generate one or more of a transaction interface input signal based upon/responsive to the communications with the user device 3000.

The transaction interface input signal may be associated with one or more of a monetary transaction via the transaction system 1000, goods 1006 to be purchased via the transaction system 1000, and/or services to be purchased via the transaction system 1000. For example, without limitation, the transaction interface 1024 may be utilized to select payment type, payment refund, and/or the goods 1006 to be purchased and/or dispensed from the transaction system 1000 upon completion of a transaction therewith. For another example, without limitation, the transaction interface 1024 may be operable to emit and/or generate a transaction interface input signal related to goods 1006 and/or the goods associated with a goods indicator 1008 that may be selected via the transaction interface 1024. The transaction interface 1024 may comprise, without limitation, one or more of a button, keypad, touchscreen, knob, dial, switch, touch-sensitive device, a wireless communicator, a Bluetooth communicator, a near-field communicator, and any combination(s) thereof, and any other component(s) or devices that may be used as the transaction interface 1024 as may be understood by those who may have skill in the art.

Some embodiments of the present invention may include one or more of an indicator 1026. The indicator 1026 may be carried by, mounted on, and/or mounted to the user interface 1003 and/or the user interface body member 1002. The indicator 1026 may be in communication with one or more of the powered components, such as, and without limitation, the controller 4002 and the power unit 4008. The indicator 1026 may be utilized and/or operable to emit and/or generate a light indication. The indicator 1026 may also be utilized and/or operable to emit and/or generate a light indication associated with one or more of a status of the transaction system 1000 and/or one or more of the powered components. Also, the controller 4002 may be configured to control and/or selectively control the indicator 1026 to emit and/or generate a light indication associated with one or more of a status of the transaction system 1000 and/or one or more of the powered components. The status may include, without limitation, an indication related to the transaction system 1000 and/or one or more of the powered components including, standby status, maintenance needed, operation failure, network connected, network connection failure, the inventory 1004 of goods 1006, possible damage detected, jammed goods 1006, and/or possible detected tampering with the transaction system 1000. The indicator 1026 may comprise, without limitation, one or more of a lightbulb and/or a light emitting diode (LED).

Some embodiments of the present invention may include a transaction operator 1028. The transaction operator 1028 may be carried by one or more of the user interface 1003 and/or the user interface body member 1002. The transaction operator 1028 may be in communication with one or more of the powered components, such as, and without limitation, the controller 4002 and/or the power unit 4008. The transaction operator 1028 may be configured and/or operable to emit and/or generate a transaction operator signal. The transaction operator 1028 may also be configured and/or operable to emit and/or generate a transaction operator signal upon and/or responsive to being activated and/or operated. The transaction operator 1028 may comprise, without limitation, one or more of a button, a switch, a dial, a key, a knob, a lever, and/or any combination(s) thereof. The controller 4002 may receive the transaction operator signal and the controller 4002 may be configured and/or operable to take a predetermined action based on and/or responsive to the transaction operator signal received. For example, and without limitation, The controller 4002, based on and/or responsive to a transaction operator signal received thereby, may cause and/or selectively control one or more of the powered components to take a predetermined action comprising one or more of end/cancel a pending transaction, issue a refund, move the user interface 1003 to the retracted position, move the user interface 1003 between the raised position and the lowered position, restart a transaction, and/or any combination(s) thereof.

Now referring back to FIGS. 1-6, some embodiments of the present invention may include one or more of a detection unit 1018. The detection unit 1018 may be carried by, mounted on, and/or mount to one or more of the user interface 1003, the user interface body member 1002, and/or the main body member 1001. The detection unit 1018 may be in communication with one or more of the powered components, including, without limitation, the controller 4002, the power unit 4008, the network unit 4004, the network 4050, and/or the user device 3000. The detection unit 1018 may be configured and/or operable to sense, detect, identify, and/or determine one or more of a height, a distance, and/or a proximity of an object, person, user, and/or customer relative to the detection unit 1018, the user interface 1003, the user interface body member 1002, the main body member 1001, and/or the transaction system 1000. The detection unit 1018 may be configured and/or operable to emit and/or generate a detection signal based on and/or responsive to a height, distance, and/or proximity sensed, detected, identified, and/or determined by the detection unit 1018. Examples of the detection unit 1018 include, without limitation, one or more of an ultrasonic sensor, an infrared sensor, a laser sensor, a capacitive sensor, an inductive sensor, a photoelectric sensor, and any combination or combinations thereof and any other sensor that may be used as the detection unit 1018 as may be understood by those who may have skill in the art.

The detection unit 1018 may comprise a height detection sensor. The detection unit 1018 and/or the height detection sensor may be configured and/or operable to sense, detect, identify, and/or determine a height of an object, person, user, and/or customer. The height sensed, detected, identified, and/or determined by the detection unit 1018 and/or the height detection sensor of the object, the person, the user, and/or the customer may be relative to the detection unit 1018, the user interface 1003, the user interface body member 1002, the main body member 1001, and/or the transaction system 1000. The detection unit 1018 and/or the height detection sensor may be configured and/or operable to emit and/or generate a height detection signal based on and/or responsive to the height sensed, detected, identified, and/or determined by the detection unit 1018 and/or the height detection sensor.

One or more of the powered components may receive the height detection signal and/or the detection signal, and the one or more powered components make take a predetermined action based on the height detection signal and/or the detection signal received. For example, without limitation, the actuation member 2004 may be configured and/or operable to move the user interface 1003 between the raised position and the lowered position based on and/or responsive to the height detection signal and/or the detection signal received. For another example, without limitation, the controller 4002 may be configured and/or operable to control and/or selectively control the actuation member 2004 to move the user interface 1003 between the raised position and the lowered position based on and/or responsive to the height detection signal and/or the detection signal received. For yet another example, without limitation, the extension unit 2006, 2007 may be configured and/or operable to move the user interface 1003 between the retracted position and the extended position based on and/or responsive to the height detection signal and/or the detection signal received. Also, for yet another example, the controller 4002 may be configured and/or operable to control and/or selectively control the tension unit 2006, 2007 to move the user interface 1003 between the retracted position and the extended position based on and/or responsive to the height detection signal and/or the detection signal received.

The detection unit 1018 may also comprise a proximity sensor. The detection unit 1018 and/or the proximity sensor may be configured and/or operable to sense, detect, identify, and/or determine a proximity distance of an object, person, user, and/or customer. The proximity distance sensed, detected, identified, and/or determined by the detection unit 1018 and/or the proximity sensor of the of the object, the person, the user, and/or the customer may be relative to the detection unit 1018, the user interface 1003, the user interface body member 1002, the main body member 1001, and/or the transaction system 1000. The detection unit 1018 and/or the proximity sensor may be configured and/or operable to emit and/or generate a proximity signal based on and/or responsive to the proximity distance sensed, detected, identified, and/or determined by the detection unit 1018 and/or the proximity sensor.

One or more of the powered components may receive the proximity signal and/or the detection signal, and one or more of the powered components make take a predetermined action based on the proximity signal and/or the detection signal received. For example, without limitation, the extension unit 2006, 2007 may receive the proximity signal and/or the detection signal, and the extension unit 2006, 2007 may move the user interface 1003 between the extended position and the retracted position based on and/or responsive to the proximity signal and/or the detection signal received. For another example, without limitation, the controller 4002 may receive the proximity signal and/or the detection signal, and the controller 4003 may control and/or selectively control the extension unit 2006, 2007 to move the user interface 1003 between the extended position and the retracted position based on and/or responsive to the proximity signal and/or the detection signal received. The extension unit 2006, 2007 may be configured, operable, and/or controlled to move and/or maintain the user interface 1003 between the extended position and the retracted position at the proximity distance sensed by the detection unit 1018 and/or proximity sensor.

For another example, without limitation, upon one or more of the powered components, such as the controller 4002, receiving the proximity signal and/or the detection signal from the detection unit 1018 and/or the proximity sensor, the detection unit 1018 and/or the height detection sensor may be configured, operable, activated, and/or controlled to sense, detect, identify, and/or determine the height of the object, the person, the user, and/or the customer associated with the detection signal/proximity signal. The detection unit 1018 and/or the height detection sensor may then emit and/or generate a height detection signal and/or a detection signal related to the height of the object, the person, the user, and/or the customer sensed, detected, identified, and/or determined. Based upon and/or responsive to the height detection signal and/or the detection signal, the actuation member 2004 may be configured, operable, and/or selectively controlled by the controller 4002, to move the user interface between the raised position and the lowered position.

Also, the actuation member 2004 and/or the controller 4002 may be configured and/or operable to determine and/or identify a user position. The user position may be determined and/or identified based upon and/or responsive to one or more of the height detection signal and/or the detection signal and a predetermined offset. The predetermined offset may be related to an offset distance from the sensed height of the user so that the user interface 1003 may be positioned between the raised position and the lowered position and at a height comparable to an estimated height of a localized area of the person, the user, and/or the customer sensed, detected, identified, and/or determined. The localized area of the person, the user, and/or the customer sensed, detected, identified, and/or determined may comprise, without limitation, one or more of the head, eyes, face, shoulders, chest, elbows, waist, and/or abdomen of the person, the user, and/or the customer sensed, detected, identified, and/or determined.

For example, without limitation, the actuation member 2004 and/or the controller 4002 may be configured and/or operable to determine and/or identify a user position based upon and/or responsive to the height detection signal/the detection signal and a predetermined offset related to an offset distance from the sensed height of the user, and the actuation member 2004 may be configured, operable, and/or selectively controlled to move the user interface 1003 to the user position and between the raised position and the lowered position such that the user interface 1002 may be positioned at a height comparable to an estimated height of a localized area of the person, user, and/or customer sensed, detected, identified, and/or determined, with the localized area comprising the head, eyes, face, shoulders, chest, elbows, waist, and/or abdomen of the person, the user, and/or the customer.

In some embodiments of the present invention, some signals may have and/or may be assigned a priority over other signals for which the actuation member 2004 to move the user interface 1003 and/or for which the controller 4002 controls and/or selectively controls the actuation member 2004 to move the user interface 1003, based upon and/or responsive to that prioritized signal over the other non-prioritized signal(s). For example, without limitation, the input height signal may have or may be assigned a priority over the detection signal, the height detection signal, the proximity signal, the sensed audio signal, and/or the input extension signal such that the actuation member 2004 may move and/or be controlled to move the user interface 1003 based upon and/or responsive to the input height signal over the detection signal, the height detection signal, the proximity signal, the sensed audio signal, and/or the input extension signal.

In some embodiments of the present invention, the actuation member 2004 may move and/or be controlled to move the user interface 1003 based upon and/or responsive to the prioritized input height signal and ignore the detection signal, the height detection signal, the proximity signal, the sensed audio signal, and/or the input extension signal. In some other embodiments of the present invention, after the actuation member 2004 has moved and/or has been controlled to move the user interface 1003 based upon and/or responsive to the prioritized input height signal, the actuation member 2004 may then move and/or be controlled to move the user interface 1003 based on one or more of the detection signal, the height detection signal, the proximity signal, the sensed audio signal, and/or the input extension signal.

In some embodiments of the present invention, signals that may cause the actuation member 2004 to move the user interface 1003 between the raised position and the lowered may have a priority and/or may be assign a priority over signals that may cause the extension unit 2006, 2007 to move the user interface 1003 between the retracted position and the extended position. For example, without limitation, the input height signal and/or the height detection signal may have and/or may be assigned a priority over the input extension signal such that the actuation member 2004 may move and/or be controlled to move the user interface 1003 between the raised position and the lowered position before the extension unit 2006, 2007 moves and/or is controlled to move the user interface between the extended position and the retracted position.

In some embodiments of the present invention, the controller 4002 may be configured and/or operable to determine that a predetermined amount of time has passed since a detection signal, a height detection signal, a proximity signal, a sensed audio signal, an input height signal, and/or an input extension signal has been received by the controller 4002. The actuation member 2004 may be configured and/or operable to move the user interface 1003 to a height reset position between the raised position and the lowered position based upon and/or responsive to the controller 4002 determining that the predetermined amount of time has passed. Also, the controller 4002 may be configured to control and/or selectively control the actuation member 2004 to move the user interface 1003 to the height reset position between the raised position and the lowered position based upon and/or responsive to the controller 4002 determining that the predetermined amount of time has passed.

The extension unit 2006, 2007 may be configured and/or operable to move the user interface 1003 to an extension reset position between the retracted position and the extended position based upon and/or responsive to the controller 4002 determining that the predetermined amount of time has passed. Also, the controller 4002 may be configured to control and/or selectively control the extension unit 2006, 2007 to move the user interface 1003 to the extension reset position between the retracted position and the extended position based upon and/or responsive to the controller 4002 determining that the predetermined amount of time has passed.

In some embodiments of the present invention, the height reset position and/or the extension reset position may be programmable and/or updateable. The height reset position and/or the extension reset position may be programmable and/or updateable, without limitation, via the transaction interface 1024, via the communication access 4010, and/or via the imputation unit 4012. In some embodiments of the present invention, the controller 4002 may be configured and/or operable to program and/or update the height reset position and/or the extension reset position by identifying and/or determining a common median height position and/or a common median extension position. The controller 4002 may identify and/or determine the common median height position and/or the common median extension position based upon and/or responsive to the user positions of a predetermined number of transactions over a predetermined period of time.

Some embodiments of the present invention may be operable and/or configured to move the user interface 1003 between the raised position and the lowered position and/or to move the user interface 1003 between the retracted position and the extended position via voice recognition. The microphone 4016 and/or the controller 4002 may be configured and/or operable to identify an input height signal and/or and input extension signal based upon and/or responsive to a sensed audio signal emitted and/or generated by the microphone. The microphone 4016 and/or the controller 4002 may be configured and/or operable to identify an input height signal and/or and input extension signal based upon and/or responsive to a sensed audio signal emitted and/or generated by the microphone via voice recognition instructions and/or algorithms.

Some embodiments of the present invention may be configured and/or operable to facilitate, conduct, and/or perform transactions via communication(s) received and/or transmitted from/with a user device 3000. Also, some embodiments of the present invention may be configured and/or operable to move the user interface 1003 between the raised position and the lowered position and/or to move the user interface 1003 between the retracted position and the extended position based upon and/or responsive to communication(s) received and/or transmitted from/with a user device 3000. The user device 3000 may comprise, without limitation, a handheld device, a smart phone, cellular device, a computer tablet, a smart watch, a personal computer, a laptop computer, and any combination or combinations thereof. The user device 3000 may be in communication with one or more of the powered components, such as, and without limitation, the network unit 4004, the controller 4002, and/or the transaction interface 1024, and communication between the user device 3000 and the one or more powered components may be via the network 4050.

The controller 4002 may be configured and/or operable to receive, interpret, and/or determine if the communications with the user device 3000 comprise one or more of a transaction, a portion of the transaction, a goods 1006 selection, a monetary transaction, a completed transaction, an input height signal, and/or an input extension signal. The user device 3000 may include an application with a graphical user interface (GUI) that may be operable to communicate with the transaction system 1000 and/or with one or more of the powered components.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

What is claimed is:

1. A transaction system comprising:
a main body member configured to hold an inventory of goods to be dispensed;
a user interface body member to be mounted to the main body member, the user interface body member comprising:
a user interface carried by the user interface body member and operable to facilitate transactions and dispense the goods responsive to the transaction;
a controller in communication with the user interface;
a detection unit in communication with the controller; and
an actuation member in communication with the controller and with the user interface;
wherein the user interface is moveable between a raised position and a lowered position;
wherein the detection unit comprises a height detection sensor to sense a height of a user;
wherein the detection unit is operable to transmit a height detection signal to the controller; and
wherein the actuation member is operable to move the user interface between the raised position and the lowered position responsive to the height detection signal.

2. The system of claim 1, further comprising at least one input member carried by the user interface body member and in communication with the controller; wherein the at least one input member is operable to generate an input height signal; and wherein the actuation member is operable to move the user interface between the raised position and the lowered position responsive to the input height signal.

3. The system of claim 2, wherein the at least one input member is defined by a first input member and a second input member; wherein the input height signal is defined by a first input height signal that is generated by operation of the first input member and a second input height signal that is generated by operation of the second input member; wherein the actuation member is operable to move the user interface towards the raised position responsive to the first input height signal and towards the lowered position responsive to the second input height signal; and wherein the input height signal is assigned a priority over the height detection signal.

4. The system of claim 1, wherein the detection unit comprises a proximity sensor to sense a proximity distance of the user relative to the user interface; wherein the proximity sensor is operable to transmit a proximity signal to the controller; and wherein the actuation member is operable to move the user interface between the raised position and the lowered position responsive to the proximity signal and to the height detection signal.

5. The system of claim 1, wherein the actuation member is operable to move the user interface to a reset position once the controller determines that a predetermined amount of time has passed since the height detection signal was transmitted by the detection unit; and wherein the reset position is predetermined and programmable.

6. The system of claim 1, wherein the user interface is operable to transmit a completed transaction signal to the controller responsive to a transaction being completed using the user interface; wherein upon receipt of the completed transaction signal, at least one of the inventory of goods is released to be dispensed from the main body member to a dispensing area.

7. The system of claim 6, wherein the dispensing area is carried by the user interface body member so that the dispensing area is moveable between the raised position and the lowered position as the user interface is moved between the raised position and the lowered position.

8. The system of claim 1, wherein the user interface comprises a transaction interface operable to communicate with a user device to conduct the transaction.

9. A user interface body member to be mounted on a main body member of a transaction system, the user interface body member comprising:
a user interface operable to facilitate transactions and dispense at least one of an inventory of goods carried by the main body member responsive to the transaction;
a controller in communication with the user interface;
a detection unit in communication with the controller; and
an actuation member in communication with the controller and the user interface;
wherein the user interface is moveable between a raised position and a lowered position;
wherein the detection unit comprises a height detection sensor to sense a height of a user;
wherein the detection unit is operable to transmit a height detection signal to the controller; and
wherein the actuation member is operable to move the user interface between the raised position and the lowered position responsive to the height detection signal.

10. The user interface body member of claim 9, further comprising at least one input member in communication with the controller; wherein the at least one input member is operable to generate an input height signal; and wherein the actuation member is operable to move the user interface between the raised position and the lowered position responsive to the input height signal.

11. The user interface body member of claim 10, wherein the at least one input member is defined by a first input member and a second input member; wherein the input height signal is defined by a first input height signal that is generated by operation of the first input member and a second input height signal that is generated by operation of the second input member; wherein the actuation member is operable to move the user interface towards the raised position responsive to the first input height signal and towards the lowered position responsive to the second input height signal; and wherein the input height signal is assigned a priority over the height detection signal.

12. The user interface body member of claim 9, wherein the detection unit comprises a proximity sensor to sense a proximity distance of the user relative to the user interface; wherein the proximity sensor is operable to transmit a proximity signal to the controller; and wherein the actuation member is operable to move the user interface between the raised position and the lowered position responsive to the proximity signal and to the height detection signal.

13. The user interface body member of claim 9, wherein the actuation member is operable to move the user interface to a reset position once the controller determines that a predetermined amount of time has passed since the height detection signal was transmitted by the detection unit; and wherein the reset position is predetermined and programmable.

14. The user interface body member of claim 9, further comprising a dispensing area; and wherein the user interface is operable to transmit a completed transaction signal to the controller responsive to the transaction being completed using the user interface; wherein upon receipt of the completed transaction signal, at least one of the inventory of goods is released to be dispensed from the main body member to the dispensing area.

15. The user interface body member of claim 14, wherein the dispensing area is moveable between the raised position and the lowered position as the user interface is moved between the raised position and the lowered position.

16. The user interface body member of claim 9, wherein the user interface comprises a transaction interface operable to communicate with a user device to conduct the transaction.

17. A method of dispensing at least one good from a transaction system comprising a main body member configured to hold an inventory of goods and a user interface body member to be mounted to the main body member, the method comprising:
sensing a height of a user using a detection unit in communication with a controller that is in communication with a user interface carried by the user interface body member;
transmitting a height detection signal to the controller; and
operating an actuation member that is in communication with the controller and the user interface to move the user interface between a raised position and a lowered position.

18. The method of claim 17, further comprising generating an input height signal that includes a first input height signal generated by operating a first input member and a second input height signal generated by operating a second input member; and further comprising operating the actuation member to move the user interface towards the raised position responsive to the first input height signal and towards the lowered position responsive to the second input height signal; and wherein the input height signal is assigned a priority over the height detection signal.

19. The method of claim 17, further comprising sensing a proximity distance of the user relative to the user interface using a proximity sensor; further comprising transmitting a proximity signal to the controller; and further comprising operating the actuation member to move the user interface between the raised position and the lowered position responsive to the proximity signal and to the height detection signal.

20. The method of claim 17, further comprising operating the actuation member to move the user interface to a reset position based upon determining that a predetermined amount of time has passed since the height detection signal was transmitted to the controller; and further comprising programming the reset position.
